(19) United States
(12) Patent Application Publication
(10) Pub. No.: US 2026/0036463 A1
(43) Pub. Date: Feb. 5, 2026

(54) INFLATABLE SEAL

(71) Applicant: WIPOTEC GmbH, Kaiserslautern (DE)

(72) Inventors: Christian Fleige, Kaiserslautern (DE); Alexander Schulzki, Stelzenberg (DE)

(21) Appl. No.: 19/286,537

(22) Filed: Jul. 31, 2025

(30) Foreign Application Priority Data
Aug. 2, 2024 (DE) 10 2024 122 204.2

(51) Int. Cl. G01G 21/30; F16J 15/46

(52) U.S. Cl. CPC G01G 21/30; F16J 15/46

(57) ABSTRACT

The invention relates to a modular seal for scales, having a load application element which transmits a weight force in a vertical direction Z. The seal includes a closure module with a sealing element that forms a chamber that may be acted on by pressure, and a counterbearing that includes a sealing surface. The chamber may be acted on by a medium in such a way that a sealing section rests against the sealing surface in the vertical direction z.

### REFERENCE TO PENDING PRIOR PATENT APPLICATION

This patent application claims benefit of German Patent Application No. 10 2024 122 204.2, filed Aug. 2, 2024, which patent application is hereby incorporated herein by reference.

### FIELD OF THE INVENTION

The present invention relates to a seal for scales, load cells, or force sensors, which for simplification are referred to below as “scales.” Such scales generally include a protective housing, with a load application element (also referred to as a load application bolt) that transfers a load, to be weighed, into the housing and passes through a housing opening without contact. For scales with underfloor load output, the load application element is subjected to tensile load by the force to be measured, and protrudes out of the bottom side of the housing.

### BACKGROUND OF THE INVENTION

To avoid weighing errors, contact between the load application element and the housing (force shunt) must be avoided during operation. At the same time, in particular in the production of foods or pharmaceutical products, it is often necessary to clean the scales during operating pauses, which may also take place using hot or aggressive liquids or using steam jets. In this case it is important to securely close the gap between the load application element and the housing with a seal to protect the housing interior from entry of cleaning agents.

In addition, it is desirable to lock the load application element during operating pauses in order to avoid an unintended or excessively high load on the sensitive load cell in the housing interior. Removal and installation of the seal for purposes of maintenance or repair as well as during manufacture should also be quickly and easily possible (also for the operators themselves), and positionally accurate relative to the load application element, as necessary.

Even during regular operation, it is also desirable to prevent the entry of contaminants through the gap, or the accumulation of dirt in the area of the housing opening.

Scales with an inflatable seal are known from EP 1 146 322 B1, in which an inflatable bellows that is fastened to the housing extends in the radial direction, and thus transversely to the load application direction, toward a movable part that is connected to the load application element, thereby closing the gap in between. However, the locking of the load application element is not sufficiently stable, and maintenance is laborious. In addition, this type of seal is not suitable for scales with an underfloor load output, since dirt accumulates in the labyrinth seal that is open at the top, and is difficult to remove.

### SUMMARY OF THE INVENTION

The object of the invention, therefore, is to eliminate the above-mentioned disadvantages for scales with an underfloor load output. The object is achieved by a modular seal according to claim 1, scales according to claim 11, a method according to claim 13, and a sealing element according to claim 15.

The invention is based on the finding that particularly effective sealing, and at the same time locking of the load application element, may be achieved by expanding a sealing element in parallel to the longitudinal extension of the load application element and in the direction of the load application. The seal introduces forces in two mutually orthogonal directions into a counterbearing that is coupled to the load application element, thus ensuring a particularly secure seal and stable locking.

The modular seal according to the invention is provided for scales having a load application element that protrudes downwardly from a housing of the scales along a vertical direction Z. The seal includes a preferably rotationally symmetrical closure module that extends about a longitudinal axis Z_{A} running in the vertical direction Z. The closure module, as a first important component of the seal, is provided for being fixed to the scale housing in the area where the load application element is led out of the scale housing. The closure module has a central holder opening through which the load application element of the scales can protrude, or in which the load application element protrudes when the scales are in the installed state.

A portion of the closure module is a holder and an expandable sealing element that is inflatable with fluid and accommodated by the holder. The sealing element is preferably designed as an inflatable ridge or tube that extends circumferentially about the longitudinal axis Z_{A}. By changing the internal pressure of the sealing element, it may be selectively transferred from a rest state into a sealing state or back by inflating it (sealing state) or contracting it (rest state). The sealing element is preferably acted on by compressed air, although any other fluid that is preferably designed to be compressible is also conceivable.

The seal also includes, as a second important component, a counterbearing that cooperates with the sealing element and that is provided for fastening to the load application element. According to the invention, a sealing section of the sealing element is designed to rest against a sealing surface of the counterbearing in the sealing state, thereby sealing off a gap that is present between the sealing surface and the sealing element in the rest state. For this purpose, in the sealing state the counterbearing together with the load application element is acted on by the sealing element, preferably on all sides. This action on the one hand serves to securely seal off the gap that is present in the rest state and to protect the scale housing from penetration of dirt, dust, moisture, liquid, or other undesirable substances. On the other hand, the sealing element exerts a stabilizing force on the load application element which is intended to protect it from unintended, sudden forces.

According to one advantageous embodiment of the invention, the seal is designed to seal off the gap between the sealing element and the counterbearing in a gas-tight manner. The penetration of flammable gases into the scale housing may then be prevented as necessary by activating the seal, for example when an explosive gas is detected in a production room. Conversely, it is of course also possible to protect the surroundings of the scale housing from the undesirable escape of gases from the scale housing.

According to the invention, for particularly effective application of force into the counterbearing the sealing surface is situated below the sealing element in the vertical direction Z in such a way that, during the transition from the rest state into the sealing state, the sealing element, due to its expansion in the vertical direction Z, with a section thereof rests against the underlying sealing surface and exerts a force on the counterbearing which assists with the sealing. In contrast to the prior art, according to the invention the load application element is intentionally acted on in the direction of the load application, i.e., in the direction in which the load to be measured is relayed along the load application element to the measuring cell inside the scale housing.

The invention thus intentionally accepts the stress on the load application element so that in return, a particularly effective seal and at the same time preferably also secure locking of the load application element that is safe for the measuring cell can be achieved. At the same time, the sealing element also circumferentially acts with a contact force on the counterbearing in the radial direction in order to securely center and stably position the counterbearing during the sealing.

According to one advantageous embodiment of the invention, it is provided that the holder has connection means via which the holder is directly or indirectly connectable to a scale housing, the connection means being designed to center the holder opening relative to a load application element that protrudes from the scale housing. For this purpose, the holder includes suitable centering means that can cooperate with the scale housing. This may involve, for example, one or more centering pins or a centering collar (preferably provided concentrically around the holder opening) that cooperate(s) with a complementary section of the scale housing. The purpose of the centering is to precisely align the holder opening or the holder relative to the scale housing or relative to the load application element, which protrudes downwardly from the scale housing. The precise centering is important so that the most uniform action possible by the sealing element on the counterbearing in the circumferential direction is ensured in the sealing state. In addition, the centering means facilitate easy installation during manufacture, as well as replacement and reinstallation of the seal without having to make measurements/adjustments.

According to one particularly preferred embodiment, the connection means have a thread, provided centrally with respect to the holder opening, for a screw connection to a mating thread of the scale housing. The thread or the mating thread encircles the load application element or an extension coupled thereto, and at the same time is used as centering of the holder and the scale housing or the load application element relative to one another. The holder preferably has an external thread that is screwable into a matching internal thread at the scale housing, or vice versa. By means of the thread, the holder, as part of the seal according to the invention, may be precisely screwed in relative to the scale housing or load application element in a particularly easy manner (without adjustment), and may thus be installed or uninstalled in a time-saving manner.

According to one advantageous embodiment of the invention, the holder has a base at its top side facing away from the counterbearing. In the installed state of the seal, the top side of the base faces the housing of the scales, while the sealing element is situated on the bottom side of the base facing away from the scale housing. At least one feed channel, in particular a borehole, leads out from the interior of the sealing element to an opening on the top side of the base. The feed channel is advantageously used for supplying or impinging the sealing element with the fluid through the base. The opening in the feed channel on the top side of the base is situated between two sealing means that preferably concentrically surround the holder opening and preferably rest in grooves provided for this purpose.

In particular, the sealing means may be O-rings that may be inserted into the grooves. By connecting the holder to the scale housing (in particular via the screw connection described above), the base is pressed against the scale housing, thus slightly compressing the sealing means or the O-rings situated in the grooves. In this way they seal off the area of the opening to the outside and to the inside in the radial direction, so that the fluid cannot escape in these directions.

In addition, more than two grooves, which preferably each extend concentrically with respect to one another and are provided with suitable sealing means, may be advantageous, for example to allow a particularly good seal to be achieved in the radial direction.

The sealing means preferably delimit an annular channel situated in between in the radial direction, and into which the at least one feed channel opens. The fluid for the sealing element, when it is fed into the annular channel, can then spread along the annular channel and flow, via the at least one, preferably multiple, feed channel(s), through the base and into the sealing element.

In addition, more than one such annular channel may be advantageous to ensure that the sealing element is supplied with fluid. The multiple annular channels preferably extend concentrically with respect to one another, and are fluidically connected to one another in the radial direction and/or by housing channels which in each case lead out of a scale housing and into the annular channels.

It is also conceivable for the annular channel at the same time to be provided as a receptacle for the sealing elements in such a way that grooves for accommodating the sealing means form a portion of the annular channel. For example, a groove (preferably flat and/or having a rectangular cross section) extending circumferentially about the longitudinal axis, with an inner and an outer (preferably cylindrical) wall surface, would be conceivable, with the groove forming the annular channel, and at the same time being suitable for accommodating circumferential sealing means (in particular O-rings), which rest against the inner and outer wall surfaces, for example. It is then not necessary to provide separate grooves for the sealing means. It is also conceivable for such an annular channel in the area of the inner and outer wall surfaces to have a groove-like stepped design or to be deeper than in the radially intervening section, which then forms the actual annular channel. In this way, the sealing means inserted into the deeper step are fixed even better in the radial direction.

It is also conceivable to insert into the above-mentioned groove (which is preferably flat and/or has a rectangular cross section) a sealing means that essentially fills the groove, such as an annular flat seal, wherein the flat seal may have an annular recess which extends circumferentially about the longitudinal axis Z_{A} and which then forms the annular channel. The annular recess may completely pass through the flat seal in the vertical direction Z and thus divide it in two. However, the annular recess may instead be designed as a groove inside the flat seal and not completely pass through it. In any case, one or more feed channels then lead from the annular channel, thus formed, back to the sealing element in the vertical direction Z.

Supplying the fluid into the annular channel preferably takes place directly through the wall of the scale housing. For this purpose, according to one embodiment of the invention the fluid for the seal could be supplied via a housing channel provided in the scale housing, for example via a compressed air connection inside the scale housing that is closable if necessary. The compressed air could thus be led through the housing channel and to the bottom side of the scale housing in such a way that at that location it flows out of the scale housing in the area of the annular channel. Via this procedure alone, the sealing element is then particularly advantageously connected to the fluid, in particular the compressed air, by screwing the holder to the scale housing. The modular seal according to the invention to be installed is thus ready for use in a particularly simple and rapid manner. The housing channel or the compressed air connection may be opened or closed via a suitable controller in order to impinge on or inflate the sealing element with compressed air, or to relax or even actively contract it.

As an alternative to providing the fluid via a housing channel in the scale housing, the holder or the annular channel may also have a suitable connection for a separate fluid line that is provided and connected separately from the scale housing.

According to one advantageous embodiment of the invention, the annular channel together with the sealing means or grooves radially delimiting them on both sides is formed in the base of the holder, the annular channel and the grooves being introduced on the top side of the base facing away from the counterbearing, or facing the scale housing and having a design that is open at the top. When the holder is connected, in particular screwed, to the bottom side of a scale housing, the scale housing with its bottom side then closes the annular channel on its top side, and at the same time seals off the annular channel also in the radial direction via the contact with the sealing means in the grooves. When the annular channel and the grooves are provided completely in the base of the holder, at that location the scale housing, without its own grooves or an annular channel, instead may thus have an essentially flat design.

Alternatively, it is conceivable to provide the grooves and the annular channel completely in the bottom side of the scale housing facing the base, while the top side of the base of the holder may then be designed as an essentially flat surface. Even when the holder with its base is screwed against the scale housing, the annular channel is still covered in the vertical direction, and in the radial direction is sealed in the grooves via the sealing means.

It is also conceivable to provide the grooves in the base and to provide the annular channel in the scale housing, or vice versa, or even to provide the grooves and/or the annular channel partially in the base and partially in the scale housing. In any case, it is critical that the annular channel is completely formed, and closed or sealed, by the connection of the holder to the scale housing.

Lastly, in a further alternative it is conceivable to provide a flange-like intermediate piece between the holder and the scale housing, in which the above-described grooves and/or the annular channel are/is partially or completely formed. An annular channel that is formed in the intermediate piece is closed in an operationally ready manner by installing the intermediate piece between the top side of the holder and the bottom side of the scale housing. The intermediate piece may have centering means (in particular a centering collar or centering pins) that cooperate with complementary centering means at the holder and/or the scale housing. For example, a connecting piece provided at the holder may be used for centering the intermediate piece, and at the same time may be provided with a thread for screwing into a mating thread in the scale housing.

As described above, separate grooves are not absolutely necessary, even when the stated intermediate piece is used, or for forming the annular channel in the base of the holder or in the housing of the scales.

According to a further advantageous embodiment of the invention, it is provided that the sealing surface is provided (preferably rotationally symmetrically) around the longitudinal axis Z_{A}. At the same time, the sealing surface has at least one contact area, extending at an angle to the longitudinal axis Z_{A}, against which the sealing element rests in the sealing state. Compared to a sealing surface that extends horizontally, for example, such an inclined contact area has several advantages according to the invention.

On the one hand, contaminants that hamper effective sealing do not readily remain on the sealing surface, and instead slide down along the inclination, so that the sealing element can cleanly rest against the sealing surface without interfering contaminants.

On the other hand, the sealing element, when it is impinged on by fluid and thus expands downwardly in the Z direction, generates a contact force on the inclined sealing surface which may be divided into a component in the Z direction and a component extending orthogonally thereto in the radial transverse direction. Due to the impingement in transverse the direction, the counterbearing is centered all around relative to the circumferential sealing element, and is precisely fixed in its transverse position (forces acting radially in the opposite direction on the counterbearing or its sealing surface from two opposite sides cancel one another out).

The force acting on the counterbearing in the Z direction may result in the counterbearing (and the load application element supporting the counterbearing) being moved by a certain extent in the Z direction. By making use of this effect, according to a further advantageous embodiment of the invention a stop that acts opposite the Z direction is provided, which structurally limits the movement of the load application element in the Z direction. This yields the particular advantage that the load application element in the sealing state is pressed against this stop by the inflating sealing element, optionally against an elastic force, and is held there. The stop ensures that a further increase in impingement or an unintentional impact to the load application element during cleaning, for example, is not relayed to the sensitive measuring cell in the scale housing, and instead is intercepted by the stop.

The contact area preferably has an inclined design such that its distance from the longitudinal axis Z_{A} increases with increasing distance Z from the closure module. The contact area then has the shape of a cone or a pyramid, for example, at least in sections. However, the contact area could also have the shape of a spherical segment or some other surface which in any case radially expands with increasing distance from the closure module. This shape ensures that the dirt which possibly accumulates on the contact area slides off on the inclined contact area. The dirt then falls downwardly on the side of the counterbearing, for example, without being able to interact with the seal.

Alternatively, it would be conceivable for the contact area to have an essentially funnel-shaped design, so that the contact area tapers toward the longitudinal axis with increasing distance from the closure module. Contaminants would then slide downwardly in the Z direction, and at the same time would slide radially inwardly along the contact area. An opening could be provided at the lower end of the contact area in order to discharge the contaminants.

According to a further advantageous embodiment of the invention, it is provided that the holder has at least one support section for supporting the sealing element in the radial direction or for blocking an undesirably large expansion in this direction. This may be a preferably cylindrical wall, provided concentrically with respect to the longitudinal axis Z_{A}, as an inner support section which is situated between the sealing element and the longitudinal axis Z_{A} in the radial direction, and which thus blocks the sealing element from unintentional radially inward expansion, or even blocks undesirable contact with the load application element. In addition, the inner support section prevents or reduces wrinkling of the sealing element on its radially inner side when it inflates, since otherwise the radially inwardly expanding material of the sealing element could compress and form wrinkles.

Additionally or alternatively, an outer support section may be provided on the radially outer side of the sealing element facing away from the longitudinal axis. This support section supports or blocks the sealing element against an unintentional radially outward expansion. In addition, the outer support section is preferably designed as a cylindrical wall that extends concentrically with respect to the longitudinal axis Z_{A}.

Each of these support sections is also used to facilitate and guide the expansion of the sealing element primarily in the Z direction, while a radial expansion transverse thereto is to be prevented to the greatest extent possible. Both support sections together, for example as concentric cylindrical sections, may form between one another a groove which extends circumferentially about the longitudinal axis, and which accommodates the sealing element and which in the Z direction is delimited at the top by the base of the holder. According to one advantageous embodiment, the outer support section may be longer than the inner support section in the Z direction. The two support sections thus advantageously adapt to a downwardly sloping contact surface at the counterbearing. To prevent the inflating sealing element from being outwardly deflected or deformed in the radial direction after contact with the inclined sealing surface, the outer support section may thus be guided lower than the inner support section in the Z direction, as illustrated in FIG. 2, for example.

The holder is preferably open on its bottom side facing away from the base, thus preventing accumulation of contaminants in the holder.

In its interior the sealing element preferably has a dimensionally stable core which preferably circularly extends about the longitudinal axis Z_{A}. The core is used, among other things, to support the interior of the sealing element in a dimensionally stable manner. In addition, the core is preferably connectable, in particular screwable (core screw connection) to the holder in order to fix the sealing element to the holder. The core is preferably made of aluminum. Other materials are likewise conceivable, and the seal according to the invention or its individual components or combinations thereof may be manufactured by turning, milling, injection molding, or 3D printing (additive manufacturing), for example.

The core also preferably provides at least one fluidic connection which leads from the interior of the sealing element to a feed channel, mentioned above, that is formed in the holder. One end of the feed channel preferably opens in the radial direction between a maximum outer dimension and a minimum inner dimension of the annular core, most preferably exactly between the two dimensions (middle position) on a pitch circle having a radius r.

According to one advantageous embodiment of the invention, it is also provided that a bottom side of the core facing the counterbearing has an undulating design in the vertical cross section. The undulation is selected in such a way that a borehole that leads through the core into the sealing element and that is used to fasten the core to the holder via a core screw connection or as a feed channel, opens into a wave trough. In this way, contact or even damage is avoided between the material of the sealing element, which is relaxed in the rest state, and the possibly sharp-edged hole opening of the borehole or of the channel, since the preferably rounded wave crests adjoining the wave trough support the sealing element on both sides of the channel or the borehole and are kept at a distance therefrom.

A wave trough is preferably situated at the middle position when a feed channel or a fastening hole opens at that location. Due to the rounded wave crests of the core, the core has no sharp edges or protrusions that could endanger the sealing element, in particular in the pressureless state.

To allow the deformation of the sealing element to be influenced in a targeted manner, according to one advantageous embodiment of the invention the sealing element has a special feature. Accordingly, the preferably one-piece sealing element has a head region that faces the counterbearing and surrounds the sealing section, and wall regions that adjoin the head region on the inside and on the outside in the radial direction. The wall regions extend predominantly in the Z direction, while the head region is provided essentially perpendicular thereto. According to the invention, the wall thickness of the sealing element at the head region is greater than at at least one wall region. The wall region, which is thus thinner, is then less stable against tensile forces in the vertical direction or is more easily extendable in the Z direction, compared to the thicker and therefore more stable head region. This applies in particular when the sealing element is made of a homogeneous material. According to the invention, as a result of fluid impingement on the sealing element, upon further reduction of its wall thickness primarily the at least one thinner wall region is stretched in the Z direction toward the counterbearing, and the head region is thus moved or displaced essentially in the straight Z direction toward the counterbearing. This is achieved particularly advantageously when both wall regions are formed on both sides of the head region according to this principle. The sealing element then expands downwardly, quasi-parallel to the Z direction. At the same time, the optionally provided support sections described above prevent radial expansion of the sealing element.

Scales according to the invention include a seal, described above, and a load application element that extends through the holder opening without contact and that is connected to the counterbearing. In the sealing state, by impingement on the sealing surface the sealing section prevents penetration of foreign matter into the scale housing. A preferably provided stop against which the counterbearing or the load application element is movable protects a measuring cell situated in the scale housing from unintentional or sudden high stresses. The scales may operate in particular according to the principle of electromagnetic force compensation. Other measurement principles, for example strain gauges or vibrating wires, are also conceivable.

The sealing element has an elastic design to allow inflation or expansion to the sealing state under the action of pressure. In contrast, in the relaxed state the sealing element in any case preferably contracts until the sealing element no longer contacts the counterbearing, most preferably with creation of a gap having a predefinable minimum width.

To ensure that in the rest state the counterbearing can move freely or is no longer contacted by the sealing element, according to a further advantageous embodiment of the invention it is provided that the interior of the sealing element may be acted on by a negative pressure relative to ambient pressure. The contraction of the sealing element for the transition into the rest state may thus be actively carried out, since the fluid introduced into the sealing element is drawn out in a targeted manner. A tensile force that is directed away from the sealing surface is thus generated in the sealing section contacting the sealing surface, and a section of the sealing possibly to element adhering the counterbearing may thus be lifted or separated therefrom in a targeted manner to avoid a force shunt. In particular, there is no risk of damage to the sealing element when the core has an undulating design without sharp edges.

Monitoring of the pressure prevailing in the sealing element may also be used to detect a defective seal or adhesion thereof to the counterbearing.

The modular seal according to the invention is a compact, space-saving module. It is provided as a ready-to-install assembly kit for each track of the scales, and is mounted on the scale housing and ready for use in a few seconds. Special adjustment or external testing is not necessary, since loose individual parts are not present. For rapid and positionally accurate installation of the holder, the module has a preferably pre-finished thread for centered screwing into a scale housing, two O-rings for sealing the annular channel at the scale housing, and a sealing element with an internal core. Wrench flats are also preferably provided on the outer side of the holder to allow the housing to be screwed into the scale housing and tightened, preferably with a precisely defined torque, using common tools (open-end wrenches, socket wrenches).

The seal according to the invention is provided for scales having an underfloor load output, in which the load application element thus typically extends downwardly out of the scale housing in the vertical direction. However, according to one alternative, use of this seal is also suitable in principle for scales in which the load application element protrudes horizontally from the side of the scale housing. A load to be detected by the scales is then preferably also introduced into the scale housing in the horizontal direction or along the longitudinal direction of extension of the load application element. For this purpose, the embodiments illustrated in the figures only need to be conceptually rotated on the side by 90°.

The seal according to the invention is advantageously also particularly suited for multitrack scales, which in each case are spaced close together. Since the sealing element in each case expands in the vertical direction, it advantageously requires only a small expansion space transverse thereto, i.e., in the direction of the neighboring scales. The seal may be installed using a simple tool, such as a socket wrench, that is connectable to the holder in the vertical direction Z without having to utilize a space to the side of the scale housing for the tool or its manipulation. The holder may have wrench flats that are suitable for this purpose.

The sealing element (with an internal core) may be the subject matter of a divisional application, independently of the scales or the counterbearing. All features of the sealing element and of the core described in the present patent application (also in the description of the figures and in claim 15) apply to this subject matter singly or in any given combination. These features include in particular:
The sealing element is rotationally symmetrical.
The sealing element is an inflatable ridge.
The sealing element has a head region and at least one, preferably two, wall region(s) with a reduced wall thickness relative to the head region.
The core is designed for fixing the sealing element to a holder.
For fixing the sealing element, the core encompasses at least one mounting section of the sealing element on its inner side, with a protrusion that is shaped to complement the mounting section.
On a preferably flat outer surface facing away from the core, the sealing element has at least one indentation in the vertical direction Z that is situated opposite from a protrusion of the core in the vertical direction Z. During the fastening, in particular the screw connection, of the core to a holder, the protrusion presses on the inner side of the sealing element on the section having the indentation on the outside. The indentation is thus widened and flattened, preferably until it disappears and a flat contact surface forms at the holder. The clamping force is thus more broadly distributed in the radial direction.
The core has an undulating surface, at least in sections, to avoid sharp-edged contact with the inner side of the sealing element.
The core has at least one borehole leading out from the interior of the sealing element, via which the sealing element may be supplied with fluid or fastened to a holder.

### BRIEF DESCRIPTION OF THE DRAWINGS

One embodiment of the invention is explained in greater detail below based on examples in the figures, as follows:

FIG. 1 shows scales with two underfloor load outputs and two seals according to the invention,

FIG. 2 shows a simplified sectional illustration of a modular seal according to the invention in the rest state,

FIG. 3 shows a simplified detailed view of the holder with a sealing element inserted therein, and

FIG. 4 shows a partially cutaway oblique view of the holder.

### DETAILED DESCRIPTION OF THE PREFERRED EMBODIMENTS

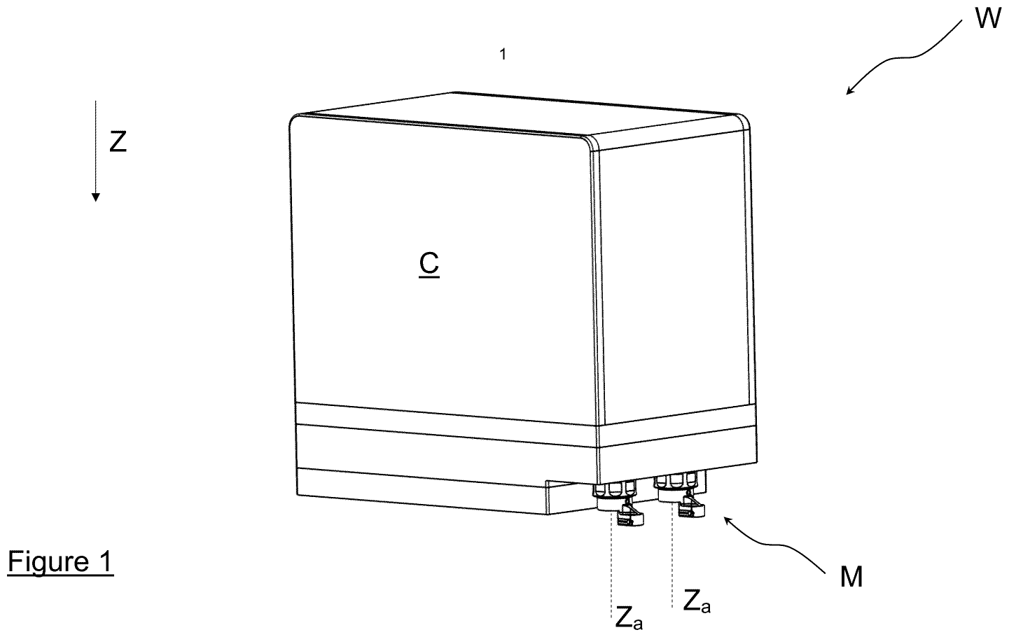

FIG. 1 shows a perspective illustration of the housing C of multitrack (dual-track) scales W, which include two sensors, situated inside the housing C and not illustrated in greater detail, for detecting a weight force. The scales are equipped with an underfloor load output, so that for each sensor a dedicated load application element on the bottom side of the scales protrudes downwardly through a separate housing opening O_{G} in the housing C in order to be acted on, outside the housing, by a force to be measured. For each load application element (also referred to as a load receptor, load application bolt, or load bolt), a modular seal M according to the invention is provided which extends essentially rotationally symmetrically in each case about an associated longitudinal axis Z_{A} running in the vertical direction Z.

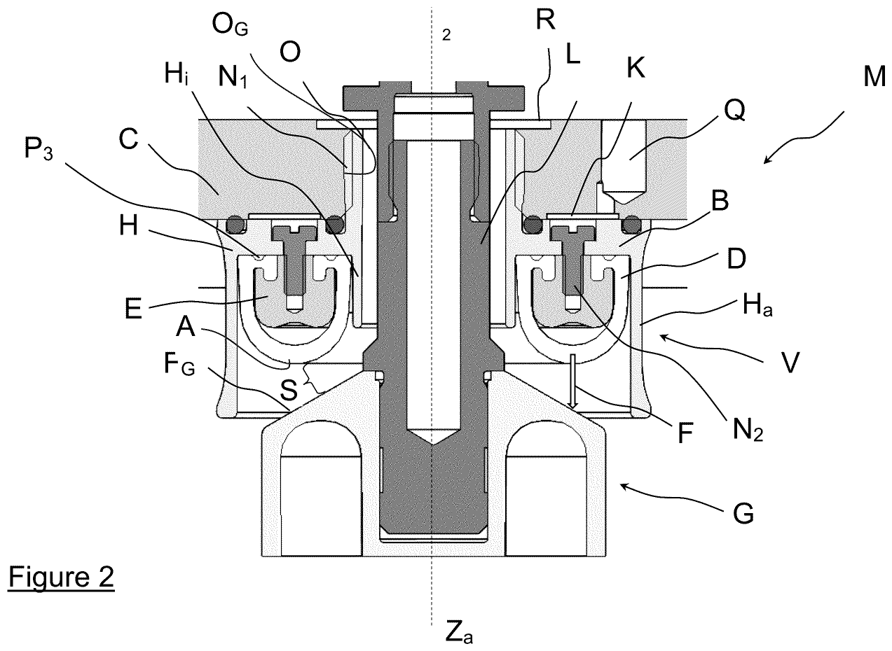

FIG. 2 shows a sectional illustration of details of a modular seal M according to the invention, which is connected to a lower, horizontal section of the housing C of the scales. A load application element L protrudes downwardly in the vertical direction Z, through the housing opening O_{G} in the bottom side of the housing C and out of the housing. Via elements not illustrated in greater detail, a force to be measured may be introduced as a tensile force into the load application element L in the vertical direction Z, and conducted upwardly by the load application element into the interior of the scale housing C to a force sensor. In this embodiment, the load application element L includes at least two elements that are screwable to one another in the vertical direction z.

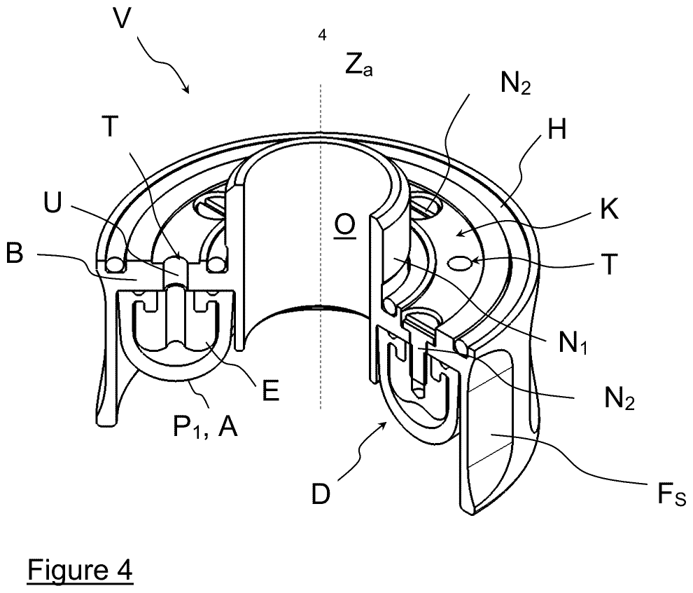

A closure module V, as part of the modular seal, includes a holder H having a rotationally symmetrical design about the longitudinal axis Z_{A}, and a flange-like base B facing the scale housing C. A thread N₁ (external thread) is provided on a connecting piece that upwardly and centrally protrudes from the base B, as also shown in FIG. 4. The connecting piece is screwed into a matching mating thread (internal thread) in the base of the housing C. The holder H is automatically centered relative to the housing opening O_{G} and to the load application element L by this screw connection. To allow the holder H to be screwed into the scale housing C in a particularly easy manner and preferably with a predefined torque, wrench flats F_{S} are provided at the outer circumference of the scale housing for engagement with a suitable tool, in particular an open-end wrench or socket wrench (see FIG. 4).

On the bottom side of the base B facing away from the scale housing C, two cylindrical support sections Hᵢ, Hₐ that extend in the vertical direction Z, concentrically with respect to the longitudinal axis Z_{A}, are provided, which in the radial direction form between them a groove extending circumferentially about the longitudinal axis. An annular, ridge-like elastic sealing element D that is impingeable by fluid is situated in this groove. The inner support section Hᵢ borders the holder H on the inside in the radial direction, and is used in particular to prevent expansion of the sealing element D in the direction of the load application element L. The outer support section Hₐ, which protrudes downwardly beyond the sealing element D in the vertical direction Z, borders the holder H on the outside in the radial direction and prevents expansion of the sealing element D in this direction. Both support sections are also used to support and guide the sealing element D in the vertical direction z.

A counterbearing G having a rotationally symmetrical design about the longitudinal axis Z_{A} extends below the holder H, and is fastened to a bottom free end of the load application element L via a screw connection, not illustrated in greater detail. The counterbearing has a conical sealing surface F_{G} facing the holder. The radius of the counterbearing G or of the sealing surface F_{G} increases with increasing distance Z from the holder H.

In the rest state illustrated in FIG. 2, a gap S exists between the sealing element D and the sealing surface F_{G}. In this state, the load application element L together with the counterbearing G can move relative to the holder H in the vertical direction Z, free of shunt force, and can transfer a load unhindered into the interior of the scale housing C. For maintenance or cleaning purposes the interior of the scale housing may be sealed off and protected by closing the gap S. According to the invention, this takes place by impinging the sealing element L, which is inserted into the holder H, with a fluid, and the sealing element is thus expanded in the vertical direction Z or toward the counterbearing G until it rests with a sealing section A against the sealing surface F_{G} or acts on it with a contact force F. The modular seal is then in the sealing state, and due to the closed gap S the housing opening O_{G} is sealed off from the surroundings. The counterbearing G is preferably moved downwardly far enough that the load application element L with an extended flange strikes against a stop R provided at the inner side of the scale housing C, and is thus fixed in the vertical direction.

When the fluid pressure inside the sealing element L is once again reduced, the sealing section A of the sealing element L retracts upwardly once again from the sealing surface F_{G} in the opposite vertical direction z, thus once again forming the gap S and freeing up the counterbearing together with its load application element L for regular operation.

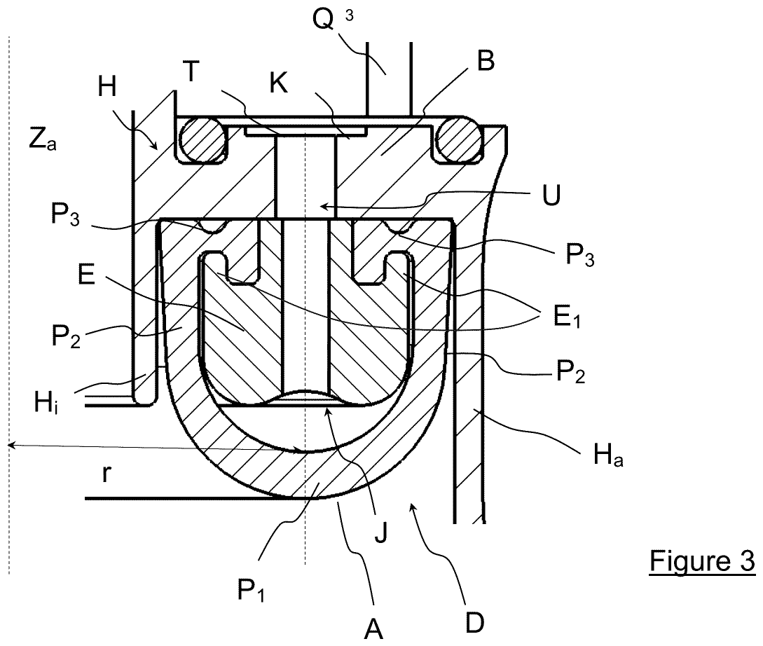

Supplying the sealing element with a fluid (in the simplest case, compressed air) is explained in particular with reference to FIG. 3. Shown there is an enlarged sectional illustration of the portion of the holder H situated to the right of the longitudinal axis Z_{A} according to FIG. 2. Shown is the elastic sealing element D, which is enclosed between the inner support element H₁ and the outer support element Hₐ, and which extends as an annular ridge about the longitudinal axis Z_{A} and has a dome-like cross section on the bottom side facing away from the base B. In this area the sealing element D includes a head region P₁, which in the radial direction transitions in one piece, to the inside and to the outside in each case, into a wall region P₂. The sealing element D has a greater wall thickness in the head region P₁ than in the two wall regions P₂. Due to the smaller wall thickness, the wall regions P₂ are more extendable in the Z direction than is the head region P₁. When the sealing element D is acted on by pressure, the wall regions P₂ are thus preferably stretched downwardly in the vertical direction Z, additionally guided by the support sections Hᵢ and Hₐ. As a result, the head region P₁ together with its sealing section A moves essentially straight down in the vertical direction Z, toward the counterbearing G.

As shown in FIGS. 2, 3, and 4, situated inside the sealing element D is an annular core E that is used in particular to stabilize the sealing element D and fasten it at its upper end to the base B. In the circumferential direction, multiple vertical boreholes are provided in the core E, on a pitch circle having a radius r. Some of the boreholes are provided with a thread for screwing the core E to the holder H (core screw connection N₂). In addition, multiple through holes are provided on the above-mentioned pitch circle in the vertical direction Z, which lead from the interior of the sealing element D through the core E and the base of the holder H, toward the bottom side of the scale housing C, as is apparent in particular in FIG. 3 and in the left portion of FIG. 4. Each of these boreholes forms a feed channel U through which the interior of the sealing element D may be supplied with and impinged by fluid. On the top side of the base B, the feed channel U at the opening T opens into an annular channel K that is concentric with respect to the longitudinal axis Z_{A}. In the example in FIGS. 3 and 4, this annular channel K is provided in the base of the holder H. As an alternative, FIG. 2 shows the provision of the annular channel K in the bottom side of the scale housing C.

Compressed air may be fed into the annular channel K via a housing channel Q that is provided in the scale housing C, and from the annular channel passes through the core E via the individual feed channels U and into the interior of the sealing element D. In the radial direction the annular channel K is sealed off by means of two O-rings situated in two mutually concentric grooves. The grooves limit the maximum usable size of the annular channel K in the radial direction on the outside and on the inside, and are introduced into the top side of the base B. (Alternatively, it is conceivable to provide the annular channel K and/or the grooves partially or completely in the bottom side of the scale housing C or in an intervening, flange-like intermediate piece. Then, for example, the top side of the base B, except for the core screw connections N₂ and the feed channels U, could have an essentially flat design).

As shown in FIGS. 2 and 3, the housing channel Q coming from the scale housing C from above opens into the annular channel K, in the radial direction between the two O-rings or grooves. In the installed state of the modular seal, the O-rings are impinged from the bottom side of the scale housing C and the top side of the base B, thus completely sealing the annular channel K.

It is apparent In FIGS. 2 through 4 that the core E has an undulating design on its bottom side facing the head region P₁. A wave trough J provided on the pitch circle having a radius r in each case adjoins a wave crest on the inside and on the outside in the radial direction. The rounded wave crests are intended to prevent the head region P₁ of the sealing element D, with its inner side facing the core E, from contacting the possibly sharp-edged region of a borehole (for a core screw connection N₂ or a feed channel U) and thus sustaining damage. Therefore, these boreholes open into the wave trough J, which in the pressureless state, supported by the adjoining wave crests, the head region P₁ cannot contact.

In the sealing state (not illustrated in the figure), the load application element L of the scales is moved downwardly in the vertical direction Z, preferably against the stop R, by the force F of the inflated sealing element D, preferably against the force of a spring (not illustrated). Due to a specifically selected or set elastic force, the mechanism/sensor system situated inside the scales is subjected to little stress, at most by this elastic force.

FIG. 3 shows two annular protrusions E₁, extending in the vertical direction Z, which are provided at the core E. On the top side of the sealing element D, two annular indentations P₃ situated opposite from the protrusions E₁ in the vertical direction Z are provided in the sealing element. Due to the screw connection of the core E to the holder H, the protrusions E₁ press upwardly on the sealing element D in the vertical direction Z, as a result of which the indentations P₃ are deformed with flattening, and at the same time the clamping force on the holder H is extended or broadened in the radial direction and thus equalized. Without such indentations P₃, a high clamping force could result on a relatively narrow area above the protrusions E₁ in the sealing element D, which is thus prevented by the indentations P₃. At the same time, the protrusions E₁ also bring about radial stabilization of the sealing element D, since it encloses the protrusions E₁ on both sides in the radial direction.

### LIST OF REFERENCE SYMBOLS

A sealing section of the sealing element
B base
C scale housing
D sealing element
E core
E₁ protrusion at the core E
F force
F_{G} sealing surface
F_{S} wrench flat
G counterbearing
H holder
Hₐ outer support section
Hᵢ inner support section
J wave trough
K annular channel
L load application element
M modular seal
N₁ thread
N₂ core screw connection
O holder opening
O_{G} housing opening
P₁ head region of the sealing element
P₂ wall region of the sealing element
P₃ indentation in the sealing element D
Q housing channel
r pitch circle radius
R stop
S gap
T opening
U feed channel
V closure module
W scales
Z vertical direction
Z_{A} longitudinal axis in the vertical direction

What is claimed is:

1. A modular seal (M) for scales, having a load application element (L) that protrudes downwardly from a housing (C) of the scales along a vertical direction (Z),
a) the seal (M) including a preferably rotationally symmetrical closure module (V) that extends about a longitudinal axis (Z_{A}) running in the vertical direction (Z), and a central holder opening (0) through which the load application element (L) can protrude,
b) wherein the closure module (V) includes a holder (H) and an expandable sealing element (D) that is accommodated by the holder (H) and inflatable with fluid, and that is selectively transferable from a rest state into a sealing state or back by changing the internal pressure of the sealing element,
c) the seal (M) further including a counterbearing (G) for fastening to the load application element (L),
d) wherein a sealing section (A) of the sealing element (D) is designed to rest against a sealing surface (F_{G}) of the counterbearing (G) in the sealing state, thereby sealing off a gap(S) that is present between the sealing surface (F_{G}) and the sealing element (D) in the rest state,
characterized in that
e) the sealing surface (F_{G}) is situated below the sealing element (D) in the vertical direction (Z) in such a way that, during the transition from the rest state into the sealing state, the sealing element (D), due to its expansion in the vertical direction (Z), rests with its sealing section (A) against the underlying sealing surface (F_{G}).

2. The modular seal (M) according to claim 1, characterized in that the holder (H) has connection means via which the holder is directly or indirectly connectable to a scale housing (C), the connection means being designed to center the holder opening (0) of the holder (H) relative to a load application element (L) that protrudes from the scale housing (C), and/or relative to the housing opening.

3. The modular seal (M) according to claim 2, wherein the connection means have a thread (N₁), provided centrally with respect to the holder opening (O), for a screw connection to a mating thread of the scale housing (C), wherein the mating thread encircles the load application element (L) and the centering takes place by means of the screw connection.

4. The modular seal (M) according to claim 1, wherein the holder (H) has a base (B) on its top side facing away from the counterbearing (G), and at least one feed channel (U), in particular a borehole, leads out from the interior of the sealing element (D) to an opening (T) on the top side of the base, and the opening (T) is situated between two sealing means and/or grooves that preferably concentrically surround the holder opening (0) and/or the housing opening (O_{g}).

5. The modular seal (M) according to claim 4, wherein the sealing means, which are preferably inserted into the grooves and also are preferably designed as O-rings, radially delimit an annular channel (K) situated in between, and wherein the grooves and/or the annular channel (K) situated between the sealing means are/is formed
a) in the top side of the base (B)
and/or
b) in a bottom side of a scale housing facing the base (B).

6. The modular seal (M) according to claim 5, wherein the annular channel (K) is sealed off by connecting, in particular screwing down or screwing in the holder (H) into a scale housing (C) by means of a thread (N₁).

7. The modular seal (M) according to claim 1, characterized in that the sealing surface (F_{G}) extends circumferentially about the longitudinal axis (Z_{A}) and has at least one contact area, extending at an angle to the longitudinal axis (Z_{A}), against which the sealing element (A) rests in the sealing state.

8. The modular seal (M) according to claim 1, characterized in that the sealing element (D) in the sealing state acts on the counterbearing (G) with a force radially in the direction of the longitudinal axis (Z_{A}), and also orthogonally thereto in the vertical direction (Z).

9. The modular seal (M) according to claim 1, characterized in that the holder (H) includes
a) an inner, preferably cylindrical, support section (Hᵢ) that radially inwardly blocks and supports the sealing element (D) against unintentional expansion, and/or
d) an outer, preferably cylindrical, support section (Hₐ) that radially outwardly blocks and supports the sealing element (D) against unintentional expansion.

10. The modular seal (M) according to claim 1, characterized in that the sealing element (D) is designed as an inflatable ridge or tube that extends circumferentially about the longitudinal axis (Z_{A}), and in its interior has a dimensionally stable core (E) which preferably circularly extends about the longitudinal axis (Z_{A}),
a) wherein the core is connectable to the holder (H), in particular screwable via a core screw connection (N₂), in order to fix the sealing element (D) to the holder (H), and/or
b) wherein the core (E) provides at least one fluidic connection from the interior of the sealing element (D) to a feed channel (U) that is formed in the holder (H), and/or
c) wherein a bottom side of the core (E) facing the counterbearing (G) has an undulating design in the vertical cross section, and an indentation incorporated into the core (E) as a wave trough (J) has the same radial distance from the longitudinal axis (Z_{A}) as a core screw connection (N₂) that connects the core (E) to the holder (H), and/or
d) wherein the sealing element has a head region (P₁) that faces the counterbearing (G) and surrounds the sealing section (A), and wall regions (P₂) that adjoin the head region (P₁) on the inside and on the outside in the radial direction, wherein the wall thickness of the sealing element at the head region (P₁) is greater than at at least one wall region (P₂), so that when the sealing element (D) is acted on by fluid, primarily the at least one wall region (P₂) is stretched toward the counterbearing (G) in the Z direction, with reduction of its wall thickness.

11. Scales (W) having a seal (M) according to claim 1 and having a load application element (L) that extends through the holder opening (0) without contact and that is connected to the counterbearing (G), wherein in the sealing state, by impingement on the sealing surface (F_{G}) the sealing section (A) partially or completely prevents penetration of foreign matter into the holder opening (0) and into the scale housing (C).

12. Scales according to claim 11, characterized in that the seal (D) is designed to move the load application element (L) in the vertical direction (Z), preferably against a stop (R), by means of the force (F), preferably against an elastic force.

13. A method for installing a modular seal, comprising:
i) providing a modular seal (M) for scales, having a load application element (L) that protrudes downwardly from a housing (C) of the scales along a vertical direction (Z),
a) the seal (M) including a preferably rotationally symmetrical closure module (V) that extends about a longitudinal axis (Z_{A}) running in the vertical direction (Z), and a central holder opening (O) through which the load application element (L) can protrude,
b) wherein the closure module (V) includes a holder (H) and an expandable sealing element (D) that is accommodated by the holder (H) and inflatable with fluid, and that is selectively transferable from a rest state into a sealing state or back by changing the internal pressure of the sealing element,
c) the seal (M) further including a counterbearing (G) for fastening to the load application element (L),
d) wherein a sealing section (A) of the sealing element (D) is designed to rest against a sealing surface (F_{G}) of the counterbearing (G) in the sealing state, thereby sealing off a gap(S) that is present between the sealing surface (F_{G}) and the sealing element (D) in the rest state,
characterized in that
e) the sealing surface (F_{G}) is situated below the sealing element (D) in the vertical direction (Z) in such a way that, during the transition from the rest state into the sealing state, the sealing element (D), due to its expansion in the vertical direction (Z), rests with its sealing section (A) against the underlying sealing surface (F_{G});
ii) screwing the holder (H) with its thread (N₁) into a matching mating thread in the scale housing (C), wherein simultaneously with the screwing
a) the holder opening (O) is centered relative to the housing opening (O_{G}) in the scales and/or to the load application element (L), and
b) on its top side facing the scales, the at least one annular channel (K) is closed in the vertical direction (Z) by the scale housing, and is sealed off in the radial direction by the sealing means that are clamped between the base (B) and the scale housing (C).

14. The method according to claim 13, characterized in that as a result of the screwing, at the same time
c) the annular channel (K) is also fluidically connected to the opening of a housing channel (Q) which is led out on the bottom side of the scale housing (C) and which provides the fluid for the sealing element.

15. A sealing element (D) for a modular seal (M) according to claim 1, wherein the sealing element (D) is designed as a reversibly elastic ridge that may be acted on by a fluid, and that is rotationally symmetrical about a longitudinal axis (Zₐ) and extends in a vertical direction (Z), and wherein the sealing element in its interior has a core (E) that is rotationally symmetrical with respect to the longitudinal axis (Z_{A}):
a) wherein the core (E), for fixing the sealing element (D) to a holder (H), encompasses at least one mounting section of the sealing element, with a protrusion that is shaped to complement the mounting section, and/or
b) wherein the core (E) has an undulating surface, at least in sections, to avoid sharp-edged contact with the inner side of the sealing element (D), and/or
c) wherein the core (E) has at least one borehole leading out from the interior of the sealing element, via which the sealing element may be supplied with fluid or fastened to a holder (H), and/or
d) wherein on a preferably flat outer surface facing away from the core (E), the sealing element has at least one indentation (P₃) that is situated opposite from a protrusion (E₁) of the core in the vertical direction (Z).
